(19) United States
(12) Patent Application Publication
(10) Pub. No.: US 2008/0060273 A1
(43) Pub. Date: Mar. 13, 2008

(54) Drive device

(75) Inventors: Marian Bochen, Eitelborn (DE); Rolf Mintgen, Thuer (DE); Christian Schindlatz, Sinzig (DE)

Correspondence Address: COHEN, PONTANI, LIEBERMAN & PAVANE, 551 FIFTH AVENUE, SUITE 1210, NEW YORK, NY, 10176, US

(73) Assignee: Stabilus GmbH, Koblenz (DE)

(21) Appl. No.: 11/899,689

(22) Filed: Sep. 7, 2007

(30) Foreign Application Priority Data
Sep. 7, 2006 (DE) 10 2006 042 023.3

(51) Int. Cl. E05F 11/24

(52) U.S. Cl. 49/340

(57) ABSTRACT

A drive device for a hatch of a motor vehicle, wherein a spindle drive is provided with a threaded spindle and a spindle nut mounted on the threaded spindle, by which drive the first fastening element and the housing tube can be driven axially relative to each other. The spindle drive can be rotatably driven by an electric motor, where the output shaft of the motor can rotate the threaded spindle or a connecting component of a clutch. The electric motor is located in the housing tube. On the inside wall of the housing tube, two or more radially oriented field magnets, which are distributed uniformly around the circumference, are provided to form a stator, where these magnets surround a coaxial, rotatably supported rotor shaft, on which coils are provided to form a rotor.

### BACKGROUND OF THE INVENTION

1. Field of the Invention

The present invention generally relates to the field of door openers and, more particularly, to a drive device for a hatch of a motor vehicle.

2. Description of the Related Art

Conventional drive devices for the hatch of a motor vehicle typically include a first fastening element that can be connected to a stationary component or to a movable component and a housing tube that is located at an-end of the drive device opposite to the first fastening element. The housing tube is able to move axially relative to the first fastening element and has a second fastening element on the end opposite the first fastening element, where it is possible to connect this second element to the movable component or to the stationary component.

The drive device also includes a spindle drive that comprises a threaded spindle and a spindle nut that is mounted on the threaded spindle. The spindle drive permits the first fastening element and the housing tube to be driven axially relative to each other. In addition, the spindle drive can be rotatably driven by an electric motor, where the output shaft of the motor can rotate the threaded spindle or a connecting component of a clutch.

In such conventional drive devices, it is known that the electric motor can be produced as a completely independent unit having its own motor housing, which is then installed in the housing tube. However, this requires not only a large number of components but also a great deal of care in the installation of the electric motor to ensure that it is coaxial to the threaded spindle or to the clutch provided in the housing tube.

It is therefore apparent there is need for a drive device of the above-indicated type which has only a small number of components and which can be installed easily.

### SUMMARY OF THE INVENTION

The foregoing and other objects and advantages are achieved in the present invention by a drive device in which an electric motor is located in an housing tube. Two or more radially oriented field magnets or coils are provided on the inside wall of the housing tube to form a stator, where each of the magnets or coils are distributed uniformly around the circumference of the housing. In addition, these magnets or coils surround a coaxial, rotatably supported rotor shaft, upon which additional coils or two or more radially oriented field magnets are provided to form a rotor, where these additional coils or magnets are distributed uniformly around the circumference of the rotor shaft. As a result of such a configuration, it becomes possible to omit the separate motor housing that is provided in the conventional drive devices. As a result, the number of required components becomes reduced, and it becomes possible to design the drive unit with a small diameter.

The housing tube thus fulfills a double function: Because the rotor shaft of the electric motor can thus be supported directly in the housing along with the threaded spindle or a connecting component, the axes of these parts cannot become offset from each other.

In accordance with the invention, the field magnets can be either permanent magnets or electromagnets. In cases where coils are mounted on the rotor, a commutator, which is connected to the coils and on which stationary slide contacts rest, is preferably installed on the rotor shaft.

The threaded spindle can be supported rotatably at one end on the housing tube, whereas it is held stationary in the axial direction with respect to the housing tube and can be rotatably driven by the electric motor; the spindle nut connected to the first fastening element can be locked against rotation with respect to the housing tube. As a result, the torque of the spindle nut is absorbed within the drive device and does not have to be supported via the fastening elements on the movable component and the stationary component.

Such a configuration makes it possible to mount the drive device in any desired orientation on the movable component and the stationary component. As a result, it becomes considerably easier to install the drive device.

The housing tube can be manufactured simply and easily by deep-drawing a metal part, for example, or by injection-molding a part out of plastic. In addition, the spindle nut can be easily connected to one end of a spindle tube coaxially surrounding the threaded spindle, where the first fastening element is permanently connected to the other end of the spindle tube. Moreover, the spindle tube can also be a metal part produced by a forming method such as deep-drawing, or it can be a plastic part produced by injection-molding.

In other embodiments of the drive device, it is possible to install a gearbox between the electric motor and the spindle drive to reduce the rotational speed and thus to increase the torque. If the gearbox consists of a cylindrical gear system and/or a planetary gear set, very little noise will be generated, and this can be reduced even more if the stages of the gearbox near the rotary drive are configured as helical gear stages.

If one or both of the fastening elements are configured as the ball heads or as the spherical sockets of ball joints, an embodiment is obtained which can be easily mounted in any desired rotational position with respect to the longitudinal axis of the drive device.

To support the force of the drive device and thus to balance the weight of the hatch and reduce the dimensions of the rotary drive, the first fastening element can be subjected to the force of a spring in the outward-travel direction, away from the housing tube. This support can extend over the entire adjustment stroke or over only a part of the stroke.

In accordance with the contemplated embodiment of the drive device, the first fastening element is actuated to obtain the adjustment by a compression spring, in particular a helical compression spring, which is supported on the housing tube. Alternatively or in addition, the first fastening element can also be actuated by gas pressure.

The force which is required to move the spindle manually is preferably selected precisely so that the hatch can be held in intermediate positions when the rotary drive is turned off or deactivated. Thus, in the case of a rotary drive in the form of an electric motor, a current-less stop position can be easily achieved.

To disconnect the electric motor from the spindle drive, the electric motor that rotatably drives the spindle drive can be actuated by a releasable clutch, which can be a positive clutch or a friction clutch.

In alternative embodiments, the clutch is provided with an engaging and disengaging function so that the clutch can be opened and closed. In particular, the clutch engages and disengages magnetically.

In other embodiments of the drive device, a separate clutch drive is omitted. Here, the clutch is configured such that it is open when the drive device is in the no-load state or is loaded in the outward-travel direction and is closed by exerting force on the drive device in the inward-travel direction. As a result, the hatch is allowed to be moved by hand with the exertion of only modest manual forces in the pulling direction of the drive device, because the electric motor and possibly the gearbox cannot exert any inhibiting forces on the spindle. In accordance with the contemplated embodiment, it becomes possible to detect obstacles and to eliminate them in an optimal manner when the hatch is being closed because no tractive forces can be transmitted.

The means for balancing the weight of the hatch are preferably configured such that a resultant moment is always acting in the closing direction. Consequently, the drive device is required to always be able to open the hatch in a motorized manner. It thus becomes necessary only to let it down at a defined speed to close the hatch.

In yet another embodiment, a guide tube which surrounds the spindle tube, thus forming a predefined gap, can be mounted on the housing tube. Here, if the helical compression spring surrounds the guide tube, while leaving a predefined gap, and is also surrounded by a jacket tube connected to the first fastening element, at another predefined gap, then the helical compression spring is both guided and protected radially both toward the outside and toward the inside.

In each of the contemplated embodiments of the invention, it is possible to protect the components of the drive device from dirt and damage by configuring the housing tube and the jacket tube so that they can telescope into and out of each other.

In other embodiments, the threaded spindle is a multi-thread spindle preferably with a lead in the range of about 10-24 mm so that the device can be operated easily and efficiently by hand.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The various features, functions and advantages characterizing the invention will be better understood by reference to the detailed description which follows, taken in conjunction with the accompanying drawings. It should be understood that the drawings are not necessarily drawn to scale and that, unless otherwise indicated, they are merely intended to conceptually illustrate the structures and procedures described herein. In the drawings, wherein like reference characters denote similar elements throughout the several views:

FIG. 1 shows a first exemplary embodiment of a drive device in accordance with the invention;

FIG. 2 shows a second exemplary embodiment of a drive device in accordance with the invention; and

FIG. 3 shows another exemplary embodiment of a drive device in accordance with the invention.

### DETAILED DESCRIPTION OF THE PRESENTLY PREFERRED EMBODIMENTS

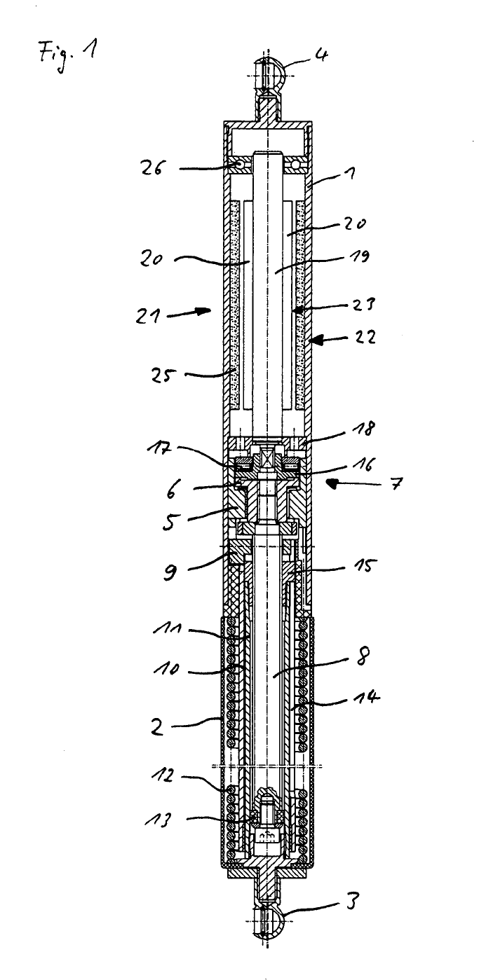

With reference to FIGS. 1-3, the drive device shown in each of the figures has a housing tube 1 made of a conductive material, such as steel, on which a jacket tube 2 is guided in a telescoping manner.

A first ball socket 3 is provided on an end of the jacket tube 2 opposite the housing tube 1, and a second ball socket 4 is provided on the end of the housing tube 1 opposite the jacket tube 2. These sockets 2, 4 make it possible to hinge the drive device to a stationary body component of a motor vehicle and to a movable component of the motor vehicle, such as a hatch of the vehicle.

A first bearing part 5 is permanently inserted in the end area of the housing tube 1 facing the jacket tube 2, in which a first clutch part 6 of a friction clutch 7 is rotatably supported. The clutch part is seated firmly on one end of a threaded spindle 8 projecting into the jacket tube 2.

A spindle nut 9 is threaded onto the threaded spindle 8 but is mounted non-rotatably with respect to the housing tube 1. The spindle nut 9 is connected to one end of a spindle tube 11, which coaxially surrounds the threaded spindle 8. The first ball socket 3 is permanently mounted on the other end of the spindle tube. Here, the spindle nut 9 is guided with a relative degree of freedom to slide axially in a guide tube 10 surrounding the spindle tube 11, where the guide tube is permanently connected to the housing tube 1.

A helical compression spring 12 is provided in the annular gap between the guide tube 10 and the jacket tube 2 surrounding it with a predefined gap. One end of the helical compression spring 12 is supported on the jacket tube 2 in the area of the first ball socket 3, the other end being supported on the housing tube 1.

At the end facing away from the first clutch part 6, the threaded spindle 8 carries a guide sleeve 13. Here, the cylindrical lateral surface of this sleeve guides the threaded spindle 8 with a freedom of axial movement in the spindle tube 11.

The guide tube 10 includes axial slots 14, which are distributed uniformly around the circumference of the tube and which extend over almost all or substantially its entire length. In the preferred embodiment, the guide tube has three axial slots.

Radially projecting support pins 15, which correspond to the axial slots 14, are arranged on the spindle nut 9. These pins project into the axial slots 14 and, thus, prevent the spindle nut 9 from turning with respect to the guide tube 10.

A second clutch part 16 is installed in the housing tube 1 at a position coaxially opposite the first clutch part 6. In certain embodiments, a ring-shaped friction lining is provided between the two clutch parts 6 and 16.

The side of the second clutch part 16 facing away from the first clutch part 6 is supported axially by an axial bearing 17 on an abutment part 18, which is permanently mounted in the housing tube 1.

In accordance with contemplated embodiments of the invention, the first clutch part 6 and the second clutch part 16 have a certain amount of play between them, so that they can move axially away from each other to break the frictional connection between them.

A rotor shaft 19 of an electric motor 21 is rotatably driveable, and is positively and non-rotatably connected to the second clutch part 16.

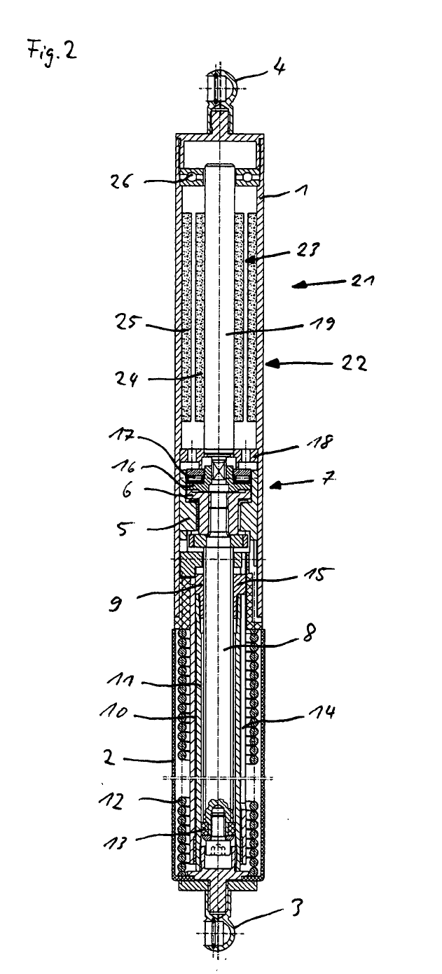

With reference to FIGS. 1 and 2, the electric motor 21 shown therein includes radially oriented field magnets 25, which are distributed uniformly around the circumference on the inside wall of the housing tube 1 to form the stator 22 of the electric motor 21.

The field magnets surround coils 20, which are mounted on the rotor shaft 19. The coils and the rotor shaft 19 together form a rotor 23 of the electric motor 21. In the exemplary embodiment of FIG. 1, the field magnets are permanent magnets 25, whereas, in the exemplary embodiment of FIG. 2, the field magnets are permanent magnets 25 and electromagnets 24.

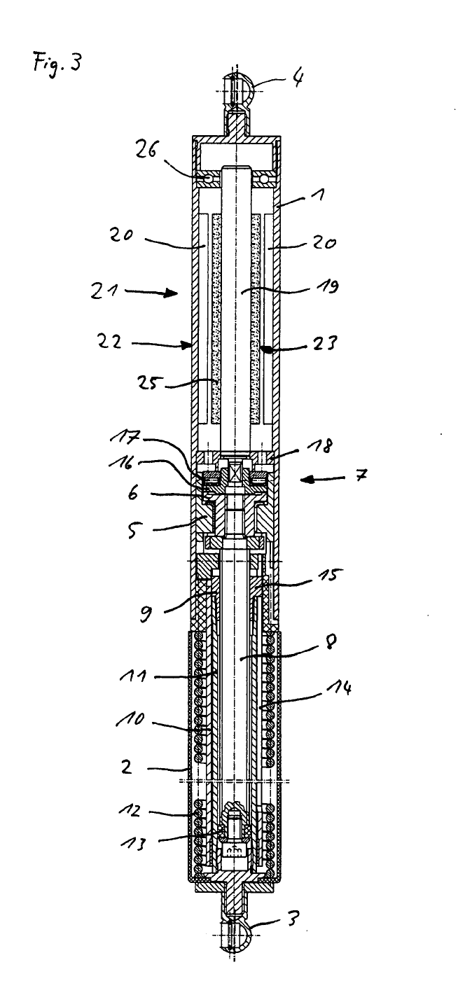

In the embodiment of the device shown in FIG. 3, the field magnets forming the rotor 23 are configured as permanent magnets 25 and are mounted on the rotor shaft 19, whereas the coils 20, forming the stator 22, are mounted on the inside wall of the housing tube 1.

In all exemplary embodiments of the drive device, the rotor shaft 19 is supported at the end facing away from the clutch 7 in an axial roller bearing 26, which is inserted into the housing tube 1.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A drive device for a hatch of a motor vehicle, comprising:
a first fastening element, which is connectable to a stationary component or a movable component;
a housing tube of conductive material, said housing tube being located at an end of the device opposite the first fastening element and axially moveable relative to the first fastening element, said housing including a second fastening element located at an end opposite to the first fastening element, said second element being connectable to the movable component or to the stationary component;
a spindle drive comprising a threaded spindle and a spindle nut mounted on the threaded spindle, said spindle drive being actualable to axially move the first fastening element relative to the housing tube;
an electric motor located in the housing tube, said electric motor being configured to rotatably drive the spindle drive, an output shaft of the motor being configured to rotate the threaded spindle or a connecting component of a clutch;
the electric motor including a stator and a rotor, wherein the stator comprises one of a plurality of radially oriented field magnets and coils provided on an inner wall of the housing, each of said plural magnets or coils being distributed uniformly around a circumference of the housing and surrounding a coaxial, rotatably supported rotor shaft of the rotor; and
the rotor comprising another one of coils and a plurality of radially oriented field magnets disposed on the rotor shaft to form a rotor, each of said coils or plural magnets being distributed uniformly around a circumference of the housing.

2. The drive device according to claim 1, wherein the field magnets of one of the stator and rotor are permanent magnets.

3. The drive device according to claim 1, wherein the field magnets of at least one of the stator and rotor are electromagnets.

4. The drive device according to claim 1, further comprising:
a commutator mounted on the rotor shaft, said commutator being connected to the coils and on which stationary slide contacts rest.

5. The drive device according to claim 1, wherein one end of the threaded spindle is rotatably supported on the housing tube, is mounted in a fixed axial position with respect to the housing tube, and is rotatably driveable by the electric motor; and wherein the spindle nut, which is connected to the first fastening element, is prevented from rotating with respect to the housing tube.

6. The drive device according to claim 5, wherein the spindle nut is connected to one end of a spindle tube coaxially surrounding the threaded spindle, the first fastening element being permanently mounted on the other end of the spindle tube.

7. The drive device according to claim 1, wherein the spindle drive is rotatably drivable by the electric motor through a gearbox.

8. The drive device according to claim 7, wherein stages of the gearbox close to the rotary drive are configured as helical gear stages.

9. The drive device according to claim 1, wherein at least one of the fastening elements comprise ball heads or ball sockets of ball joints.

10. The drive device according to claim 1, wherein the first fastening element is or can be actuated by the force of a spring in the outward-travel direction away from the housing tube.

11. The drive device according to claim 10, wherein the first fastening element is actuated by a compression spring supported on the housing tube.

12. The drive device according to claim 1, wherein the spindle drive is rotatably driveable by the electric motor through a releasable clutch.

13. The drive device according to claim 12, wherein the clutch is a positive clutch or a friction clutch.

14. The drive device according to claim 12, wherein the clutch is openable and closeable.

15. The drive device according to claim 12, wherein the clutch is open when the drive device is not under load or is under load in an outward travel direction and is closeable when the drive device is under load in an inward travel direction.

16. The drive device according to claim 6, further comprising:
a guide tube mounted in the housing tube, said guide tube surrounding the spindle tube and forming a predefined gap between the guide tube and the spindle tube.

17. The drive device according to claim 16, wherein an helical compression spring surrounds the guide tube and forms a predefined gap between the helical compression spring and the guide tube, said helical compression spring being surrounded by a jacket tube with another predefined gap between the helical compression spring and the jacket tube which is connected to the first fastening element.

18. The drive device according to claim 17, wherein the housing tube and the jacket tube inwardly and outwardly slideably engage each other in a telescoping manner.

19. The drive device according to claim 1, wherein the threaded spindle is a multi-thread spindle.

20. The drive device according to claim 1, wherein the threaded spindle has a lead of approximately 10-24 mm.

21. The drive device according to claim 11, wherein the compression spring comprises a helical compression spring.

22. The drive device according to claim 13, wherein the clutch is openable and closeable.

23. The drive device according to claims 14, wherein the clutch is magnetically engageable and disengageable.

24. The drive device according to claim 22, wherein the clutch is magnetically engageable and disengageable.

25. The drive device according to claim 13, wherein the clutch is open when the drive device is not under load or is under load in an outward travel direction and is closeable when the drive device is under load in an inward travel direction.

26. The drive device according to one of claim 16, wherein the helical compression spring surrounds the guide tube and forms a predefined gap between the helical compression spring and the guide tube, said helical compression spring being surrounded by a jacket tube with another predefined gap between the helical compression spring and the jacket which is connected to the first fastening element.
